(19) United States
(12) Patent Application Publication
(10) Pub. No.: US 2017/0129462 A1
(43) Pub. Date: May 11, 2017

(54) WINDSCREEN WIPER DEVICE

(71) Applicant: FEDERAL-MOGUL S.A., Aubange (BE)

(72) Inventor: THOMAS FRISCIONI, MEXY (FR)

(73) Assignee: FEDERAL-MOGUL S.A., AUBANGE (BE)

(21) Appl. No.: 15/322,016

(22) PCT Filed: Jul. 3, 2014
(86) PCT No.: PCT/EP2014/064233

§ 371 Date: Dec. 23, 2016

(51) Int. Cl. B60S 1/40; B60S 1/38

(52) U.S. Cl. CPC B60S 1/4087; B60S 1/387; B60S 1/3808; B60S 1/4003; B60S 2001/3898

(57) ABSTRACT

A windscreen wiper device of the flat blade type includes an elastic, elongated carrier element, as well as an elongated wiper blade of a flexible material and a connecting device for an oscillating arm with the interposition of a joint part. The said joint part is detachably connected to said connecting device by engaging protrusions provided with co-axial through holes of said connecting device in recesses provided in said joint part. An upper surface of said joint part comprises a central recess arranged to accommodate a free end of a rod-shaped oscillating arm of a first type; a L-shaped shoulder near a free end of an oscillating arm of a second type comprising a transverse pivot pin, wherein said coaxial through holes are arranged to receive said pivot pin.

### BACKGROUND

1. Technical Field

The present invention relates to a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near one end, with the interposition of a joint part, wherein the joint part is detachably connected to the connecting device by engaging protrusions of the connecting device, at the location of the pivot axis, in recesses provided in the joint part.

2. Related Art

In use, the oscillating arm is connected to a mounting head mounted on a drive shaft, wherein the oscillating arm at one end thereof is pivotally connected to the mounting head by means of a pivot pin and at another end thereof is connected to the wiper blade placed in abutment with the windscreen to be wiped. In use, the shaft rotates alternately in a clockwise and in a counter-clockwise sense carrying the mounting head into rotation also, which in turn draws the oscillating arm into rotation and by means of the connecting device moves the wiper blade. the oscillating aim can thus oscillate to-and-from between a first reversal position and a second reversal position. the first reversal position may be identified as a position, wherein the arm members extend parallel to a windscreen to be wiped and are located near a lower edge of the windscreen to be wiped.

Also, the second reversal position may be formulated as a position, wherein the arm members extend also parallel to a windscreen to be wiped and are located in a central region or near a side edge of the windscreen to be wiped.

The present invention also relates to a vehicle equipped with such a windscreen wiper device, as well as to a method for manufacturing such a windscreen wiper device.

It is noted that the present invention is not restricted to automobiles, but also refers to rail coaches and other (fast) vehicles.

Such a windscreen wiper device is generally known from European patent publication no. 1 403 156 of the same Applicant. This prior art windscreen wiper device is designed as a “yokeless” wiper device or “flat blade”, wherein no use is made of several yokes pivotally connected to each other, but wherein the wiper blade is biased by the carrier element, as a result of which it exhibits a specific curvature. In this prior art windscreen wiper device the joint part comprises at least one resilient tongue engaging in a correspondingly shaped hole provided in the oscillating arm, wherein the resilient tongue is rotatable along an hinge axis between an outward position retaining the wiper blade onto the oscillating arm and an inward position releasing the wiper blade from the oscillating arm. In order to connect the wiper blade onto the oscillating arm, the resilient tongue is initially pushed in against a spring three—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm.

The object of the invention is to provide an improved windscreen wiper device at minimum costs—without using complex machinery and additional tools—while the connecting device and the oscillating arm can be interconnected in a reliable and secure manner.

In order to accomplish that objective, a windscreen wiper device of the type referred to in the introduction is characterized according to the invention in that the protrusions of the connecting device are provided with co-axial through holes, wherein an upper surface of the joint part comprises a central recess arranged to accommodate

a free end of a rod-shaped oscillating arm of a first type;

a L-shaped shoulder near a free end of an oscillating arm of a second type, wherein the free end of the oscillating arm of the second type also comprises a transverse pivot pin, wherein the co-axial through holes are arranged to receive the pivot pin and wherein a side of the joint part is arranged to abut a leg of the L-shaped shoulder disposed at an end thereof and facing a windscreen to be wiped.

Preferably, the joint part comprises laterial retention means to restrict angular play of the oscillating arm of the first type, the joint part preferably comprises a cap provided with a protrusion in use extending in downward direction towards a windscreen to be wiped, and wherein the downwardly extending protrusion is adapted to engage in a correspondingly shaped hole provided in the oscillating arm for retaining the wiper blade onto the oscillating arm. Particularly, the cap is hingeably connected to the joint part between a closed position, wherein the wiper blade is retained onto the oscillating arm, and an open position, wherein the wiper blade can be released from the oscillating arm.

Preferably, the joint part is detachably connected to the connecting device particularly through a snapping clipping operation. Further, the protrusions that function as bearing surfaces are spaced far apart, so that the forces exerted thereon will be relatively low, the joint part is arranged to be connected to the connecting device for different types of interconnection between the wiper blade and the oscillating arm, wherein the joint part is subsequently connected to the connecting device by pivotally engaging protrusions of the connecting device, at the location of the pivot axis, in recesses provided in the joint part, and wherein the oscillating arm can be subsequently connected to the joint part. The essence of the present invention is that the connecting device and the joint part each are a universal connection for each type of interconnection between the wiper blade and the oscillating arm. A same type of the joint part to be connected to a same type of the connecting device may be used for each different type of interconnection between the wiper blade and the oscillating arm. The advantage achieved by the invention is that a unit consisting of the wiper blade, the connecting device and the joint part connected to the connecting device can be manufactured for each and every type of interconnection between the wiper blade and the oscillating arm. Thus, a universal connection between the wiper blade and the oscillating arm is obtained, so that car drivers are given the possibility to buy also non-original cheap wiper blades fitting the original oscillating arms on their cars.

The present invention thus provides a universal connecting unit (consisting of the connecting device and the joint part) that is firmly attached to the oscillating arm.

In a preferred embodiment of a windscreen wiper device in accordance with the invention the joint part has an at least substantially U-shaped cross-section at the location of its connection to the connecting device, wherein the recess is provided in the base of the U-shaped cross-section.

In another preferred embodiment of a windscreen wiper device according to the invention the joint part comprises two spaced-apart guiding protrusions extending upwardly from an upper surface of the joint part, wherein the guiding protrusions are adapted to receive the oscillating arm of the first type between them.

In another preferred embodiment of a windscreen wiper device in accordance with the invention the joint part has an at least substantially U-shaped cross-section at the location of its connection to the connecting device, wherein the joint part in each leg of the U-shaped cross-section is provided with the recess provided coaxially with the pivot axis.

In another preferred embodiment of a windscreen wiper device according to the invention the protrusions extend outwards on either side of the connecting device, wherein the protrusions and their co-axial through holes are at least substantially cylindrical.

In another preferred embodiment of a windscreen wiper device in accordance with the invention the connecting device can be pivotally connected to the oscillating arm near its free end about a pivot axis of the transverse pivot pin provided on the oscillating arm of the second type. Preferably, the joint part has an at least substantially U-shaped cross-section at the location of its connection to the connecting device, wherein the joint part in each leg of the U-shaped cross-section is provided with the recess provided coaxially with the pivot axis, the recesses being co<>axial, and wherein the co-axial recesses and the co-axial through holes of the protrusions of the connecting device are adapted to receive the pivot pin. In other words, the diameter of the pivot pin is adapted to the diameter of the bearing holes or the co-axial through holes of the protrusions of the connecting device and to the diameter of the recesses provided in legs of the U-shaped cross-section of the joint pan. In order to secure or retain the connecting device (and thus the wiper blade connected thereto) onto the oscillating arm, the oscillating arm is preferably provided with an extension comprising the pivot pin and a L-shape shoulder projecting out in the direction of the pivot pin and across the wiper blade and at the end of which is disposed a leg facing the windscreen to be wiped. Particularly, the connecting device has a width of approximately 22 mm at the location of the L-shaped shoulder.

As indicated above, the present invention also refers to a vehicle provided with a windscreen wiper device according to the invention.

The present invention also refers to a method for manufacturing a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near one end, with the interposition of a joint part, wherein the joint part is detachably connected to the connecting device by engaging protrusions of the connecting device, at the location of the pivot axis, in recesses provided in the joint part, characterized ire that the protrusions of the connecting device are provided with co-axial through holes, wherein an upper surface of the joint part comprises a central recess arranged to accommodate

a free end of a rod-shaped oscillating arm of a first type;

a L-shaped shoulder near a free end of an oscillating arm of a second type, wherein the free end of the oscillating arm of the second type also comprises a transverse pivot pin, wherein the co-axial through holes are arranged to receive the pivot pin and wherein a side of the joint part is arranged to abut a leg of the L-shaped shoulder disposed at an end thereof and facing a windscreen to be wiped.

### THE DRAWINGS

The invention will now be explained more in detail with reference to figures illustrated in a drawing, wherein

FIG. 1 is a perspective, schematic view of a windscreen wiper device of the flat blade type according to the prior art, with (a part of) an oscillating arm;

FIG. 2 shows a perspective, cross-sectional and side view of a connecting device together with a joint part in a preferred embodiment according to the invention to be used in a windscreen wiper device of the flat blade type;

FIG. 3 shows a perspective, cross-sectional and top view of the connecting device together with the joint part of FIG. 2, all with (a part of) an oscillating arm of the first type (except for a part of FIG. 3 right below); and

FIG. 4 shows a perspective, side and top view of the connecting device together with the joint part of FIG. 2, all with (a part of) an oscillating arm of the second type (except for a part of FIG. 3 in the middle).

### DETAILED DESCRIPTION

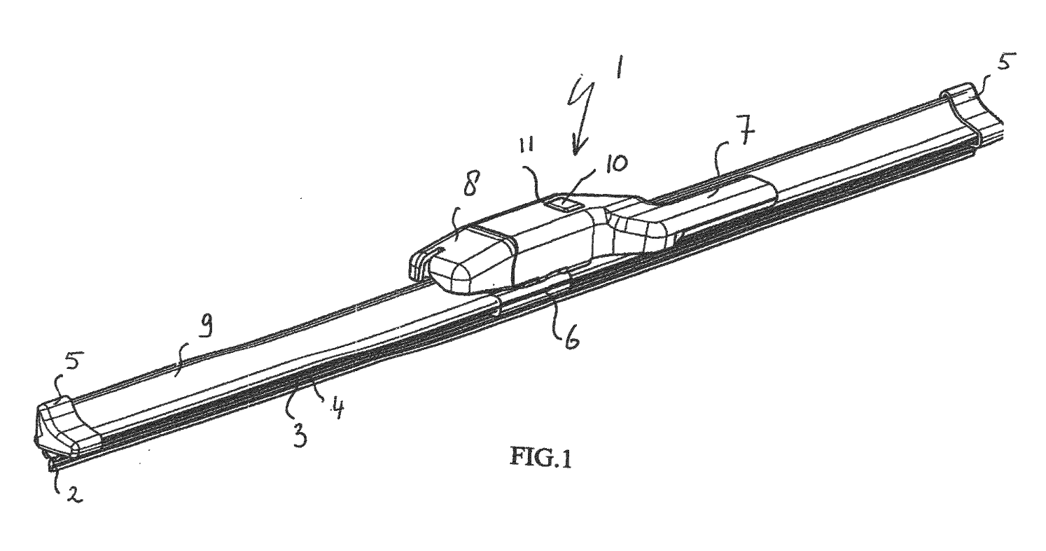

FIG. 1 shows a windscreen wiper device 1 of the flat blade type according to the prior art. the windscreen wiper device is built up of an elastomeric (rubber) wiper blade 2 comprising a central longitudinal groove 3, wherein a longitudinal strip 4 made of spring band steel is fitted in the longitudinal groove 3, the strip 4 forms a flexible carrier element for the rubber wiper blade 2, as it were, which is thus biased in a curved position (the curvature in operative position being that of a windscreen to be wiped) An end of the strip 4 and/or an end of the wiper blade 2 is connected on either side of the windscreen wiper device 1 to respective connecting pieces or “end caps” 5. In this embodiment, the connecting pieces 5 are separate constructional elements, which may be form-locked as well as force-locked to both ends of the strip 4 and/or ends of the wiper blade 2. In another variant, the connecting pieces 5 are in one piece with the strip 4 made of spring hand steel. The windscreen wiper device I is furthermore built up of a connecting device 6 of metal for connecting an oscillating wiper arm 7 thereto, with the interposition of a joint part 8. The oscillating wiper arm 7 is pivotally connected to the connecting device 6 about a pivot axis near one end. In the embodiment of FIG. 1 there is a spoiler or “air deflector” 9 which is made in one piece with the rubber wiper blade 2 and which extends along the entire length thereof.

As can be seen in FIG. 1, the joint part 8 comprises a resilient tongue 10 extending outwardly, while the oscillating arm 7 has an U-shaped cross-section at the location of its connection to the joint part 8, so that the tongue 10 engages in an identically shaped hole 11 provided in a base of the U-shaped cross-section. The connecting device 6 with the wiper blade 2 is mounted onto the oscillating arm 7 as follows. The joint part 8 being already dipped onto the connecting device 6 is pivoted relative to the connecting device 6, so that the joint part 8 can be easily slid on a free end of the oscillating arm 7. During this sliding movement the resilient tongue 10 is initially pushed in against a spring force and then allowed to spring back into the hole 11, thus snapping, that is clipping the resilient tongue 10 into the hole 11. This is a so-called bayonet-connection. The oscillating arm 7 together with the joint part 8 may then be pivoted back in a position parallel to the wiper blade 2 in order to be ready for use. By subsequently pushing in again the resilient tongue 10 against the spring force (as if it were a push button), the connecting device 6 and the joint part 8 together with the wiper blade 2 may be released from the oscillating arm 7. Dismounting the connecting device 6 with the wiper blade 2 from the oscillating arm 7 is thus realized by sliding the connecting device 6 and the joint part 8 together with the wiper blade 2 in a direction away from the oscillating arm 7.

Although not shown in FIG. 1, but fully understood by a skilled person, the oscillating arm 7 is connected to a mounting head fixed for rotation to a shaft driven by a small motor. In use, the shaft rotates alternately in a clockwise and in a counter-clockwise sense carrying the mounting head into rotation also, which in turn draws the oscillating am 7 into rotation and by means of the connecting device 6 moves the wiper blade 2.

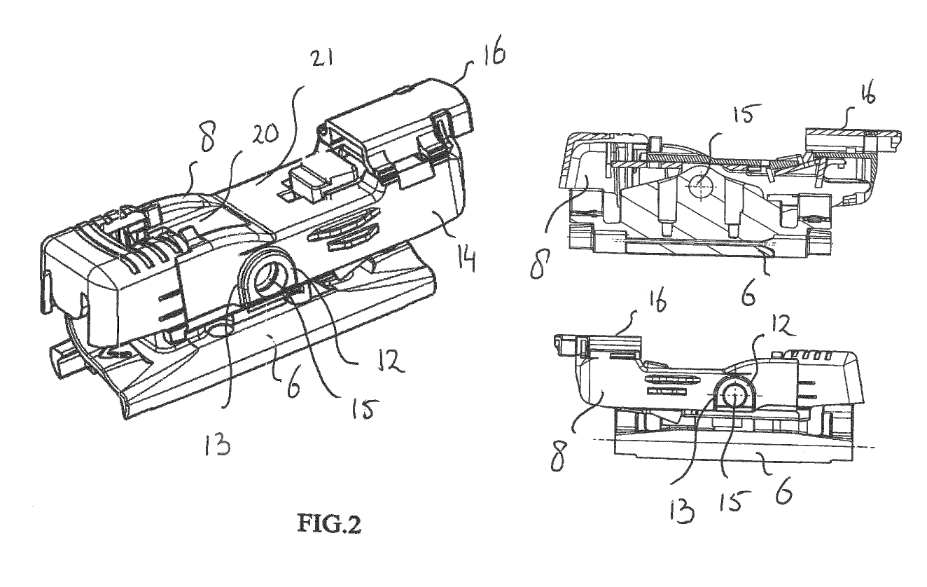

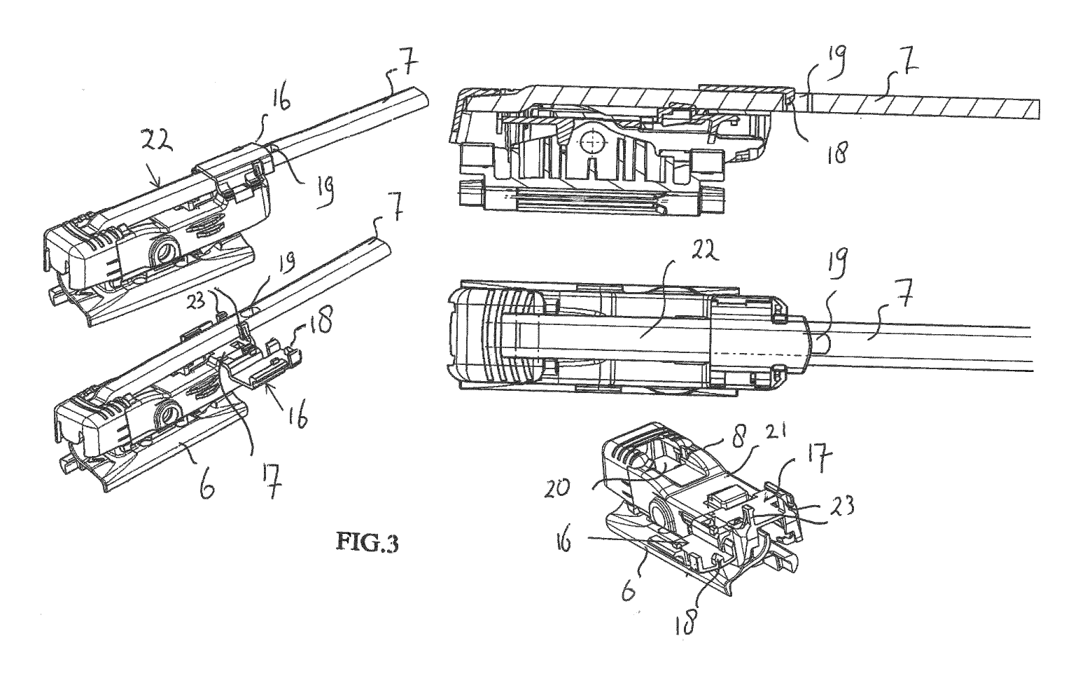

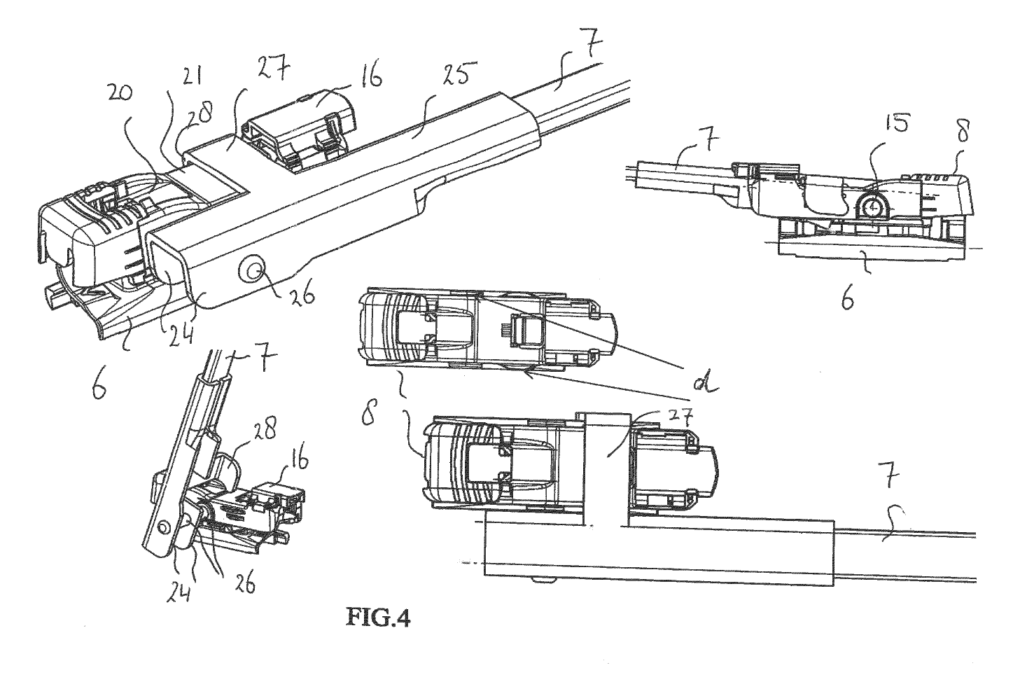

In FIG. 2 is depicted a unit consisting of a connecting device 6 and a joint part 8 detachably and pivotally connected thereto according to the invention, wherein the unit is universal part in the sense that it can be used for each and every type of interconnection between a wiper blade 2 and an oscillating arm 7, that is, for example, for the interconnection as shown in FIG. 3 on the one hand and for the interconnection as shown in FIG. 4 on the other hand. the connecting device 6 is particularly welded, soldered, glued or clamped onto two spaced-apart longitudinal strips 4 disposed on opposite sides in longitudinal grooves 3 of the wiper blade 2. In the alternative or in addition thereto, the connecting device 6 is connected to the elastomeric (rubber) material of the wiper blade, for example glued or clamped. As can be seen in FIG. 2, the connecting device 6 comprises two cylindrical protrusions 12 extending outwardly on either side thereof. These protrusions 12 pivotally engage in identically shaped cylindrical recesses 13 in legs 14 of a U-shaped cross-section of the joint part 8, the protrusions 12 function as bearing surfaces at the location of the pivot axis in order to pivot the joint part 8 (and the oscillating arm 7 attached thereto) about the pivot axis near one end of the oscillating arm 7. the protrusions 12 are provided with co-axial through holes 15 in order to allow the interconnection shown in FIG. 4, as will be explained in further detail below. The protrusions 12 are preferably in one piece with the connecting device 6. In the alternative the protrusions 12 are part of a separate pin to be inserted into opposite holes in sidewalls of the connecting device 6 (not shown).

As depicted in FIGS. 2 and 3, the joint part 8 comprises a cap 16 on an upper surface 17 thereof provided with an in use downwardly extending protrusion 18, wherein the downwardly extending protrusion 18 is adapted to engage in a correspondingly shaped hole 19 provided in the oscillating arm 7 for retaining the wiper blade 2 onto the oscillating arm 7. the cap 16 has a U-shaped cross-section, wherein the protrusion 18 extends from a base of the U-shaped cross-section of the cap 16 in downward direction in use, the cap 16 near an edge of the upper surface 17 is hingeably connected to the joint part 8 between a closed position (seen in FIG. 2 and FIG. 3 left above), wherein the wiper blade 2 can be retained onto the oscillating arm 7, and an open position (seen in FIG. 3 left below and right below), wherein the wiper blade 2 can be released from the oscillating arm 7, the joint part 8 further comprises a recess 20 in the base 21 of its U-shaped cross-section for receiving a free end 22 of the oscillating arm 7 (seen in FIG. 3). As shown in FIG. 3, the joint part 8 further comprises two spaced-apart guiding protrusions 23 extending upwardly from an upper surface 17 of the joint part 8, wherein the guiding protrusions 23 are adapted to receive the free end 22 of the oscillating arm 7 between them.

Parts in FIG. 4 that correspond to their counterparts in FIGS. 2 and 3 have been designated with the same reference numerals. In the embodiment of FIG. 4 the free end 22 of the oscillating arm 7 has a U-shaped cross-section, wherein legs 24 of the U-shaped cross-section are orientated towards a windscreen to be wiped and wherein a base 25 of the U-shaped cross-section is orientated parallel to a windscreen to be wiped. Between the legs 24 of the U-shaped cross-section and protruding in a directions towards the wiper blade 2 is a joint pin or pivot pin 26 whose pivot axis extends in a direction of the oscillating movement of the oscillating arm 7. The diameter of the pivot pin 26 is adapted to the diameter of the bearing holes or the co<>axial through holes 15 of the protrusions 12 of the connecting device 6 and to the diameter of the recesses 13 provided in legs 14 of the U-shaped cross-section of the joint part 8. In order to secure or retain the connecting device 6 (and thus the wiper blade 2 connected thereto) onto the oscillating arm 7, the oscillating arm 7 is provided with an extension comprising the pivot pin 26 and a L-shape shoulder 27 which projects out in the direction of the pivot pin 26 and across the wiper blade 2 and at the end of which is disposed a leg 28 facing the windscreen to be wiped, the connecting device 6 has a width d of approximately 22 mm at the location of the L-shaped shoulder 27.

The invention is not restricted to the variants shown in the drawing, but it also extends to other embodiments that fall within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, a joint part is detachably connected to said connecting device by engaging protrusions of said connecting device, about a pivot axis, in recesses provided in said joint part, wherein said protrusions of said connecting device are provided with co-axial through holes, wherein an upper surface of said joint part comprises a central recess arranged to accommodate a free end of a rod-shaped oscillating arm of a first type;
a L-shaped shoulder near a free end of an oscillating arm of a second type, wherein said free end of the oscillating arm of the second type also comprises a transverse pivot pin, wherein said co-axial through holes are arranged to receive the pivot pin and wherein a side of said joint part is arranged to abut a leg of the L-shaped shoulder disposed at an end thereof and facing a windscreen to be wiped.

2. The windscreen wiper device according to claim 1, wherein said joint part comprises lateral retention features arranged to restrict angular play of the oscillating arm of the first type.

3. The windscreen wiper device according to claim 1, wherein said joint part comprises a cap provided with a protrusion in use extending in downward direction towards a windscreen to be wiped, and wherein said downwardly extending protrusion is adapted to engage in a correspondingly shaped hole provided in the oscillating arm for retaining said wiper blade onto the oscillating arm.

4. The windscreen wiper device according to claim 3, wherein said cap is hingeably connected to said joint part between a closed position, wherein said wiper blade is retained onto the oscillating arm and an open position, wherein said wiper blade can be released from the oscillating arm.

5. The windscreen wiper device according to claim 1, wherein said joint part has an at least substantially U-shaped cross-section at the location of its connection to said connecting device, and wherein said recess is provided in the base of the U-shaped cross-section.

6. The windscreen wiper device according to claim 1, wherein said joint part comprises two spaced-apart guiding protrusions extending upwardly from an upper surface of said joint part, and wherein said guiding protrusions are adapted to receive the oscillating arm of the first type between them.

7. The windscreen wiper device according to claim 1, wherein said joint part is detachably connected to said connecting device through a snapping/clipping operation.

8. The windscreen wiper device according to claim 1, wherein said joint part has an at least substantially U-shaped cross-section at the location of its connection to said connecting device, and wherein said joint part in each leg of said U-shaped cross-section is provided with said recess provided coaxially with said pivot axis.

9. The windscreen wiper device according to claim 1, wherein the protrusions extend outwards on either side of said connecting device, and wherein the protrusions and their co-axial through holes are at least substantially cylindrical.

10. The windscreen wiper device according to claim 1, wherein said connecting device can be pivotally connected to the oscillating arm near its free end about a pivot axis of said transverse pivot pin provided on the oscillating arm of the second type.

11. The windscreen wiper device according to claim 10, wherein said joint part has an at least substantially U-shaped cross-section at the location of its connection to said connecting device, wherein said joint part in each leg of said U-shaped cross-section is provided with said recess provided coaxially with said pivot axis, said recesses being co-axial, and wherein said co-axial recesses and said co-axial through holes of said protrusions of said connecting device are adapted to receive the pivot pin.

12. A vehicle provided with a windscreen wiper device according to claim 1.

13. A method for manufacturing a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein said oscillating arm can be pivotally connected to said connecting device about a pivot axis near one end, with the interposition of a joint part, wherein said joint part is detachably connected to said connecting device by engaging protrusions of said connecting device, at the location of said pivot axis, in recesses provided in said joint part, wherein said protrusions of said connecting device are provided with co-axial through holes, wherein an upper surface of said joint part comprises a central recess arranged to accommodate a free end of a rod-shaped oscillating arm of a first type; a L-shaped shoulder near a free end of an oscillating arm of a second type, wherein said free end of said oscillating arm of the second type also comprises a transverse pivot pin, wherein said co-axial through holes are arranged to receive said pivot pin and wherein a side of said joint part is arranged to abut a leg of said L-shaped shoulder disposed at an end thereof and facing a windscreen to be wiped.
